(19) United States
(12) Patent Application Publication
(10) Pub. No.: US 2005/0060296 A1
(43) Pub. Date: Mar. 17, 2005

(54) Search system and method for simultaneous querying and notification of multiple web sales sites

(76) Inventors: David Scott Whitby, Salt Lake City, UT (US); Ryan Dee Smith, Salt Lake City, UT (US)

Correspondence Address: MORRISS O'BRYANT COMPAGNI, P.C., 136 SOUTH MAIN STREET, SUITE 700, SALT LAKE CITY, UT, 84101, US

(21) Appl. No.: 10/662,538

(22) Filed: Sep. 15, 2003

(51) Int. Cl. G06F 7/00

(52) U.S. Cl. 707/3

(57) ABSTRACT

A system and method for performing a search of multiple WEB sites for a desired product or service, wherein the searches are performed using the commands, protocols and native search engine of each WEB site to thereby perform the search as rapidly as possible, wherein the user does not need any knowledge of the interface to each of the WEB sites to be searched, wherein the searches can be performed automatically at a user-selectable interval, wherein the user is automatically notified whenever a desired product or service is found, and wherein subsequent updates of matching products and services are provided in incremental updates only showing additional items posted to a particular WEB site.

### BACKGROUND OF THE INVENTION

1. Field of the Invention

This invention relates generally to commerce utilizing the Internet. More specifically, the present invention provides a system and method for enabling a user to enter a search criteria that is used to simultaneously search a wide variety of web sites that might offer products and/or services that may meet the search criteria, wherein the search can be automated to be performed at regular intervals without user intervention, wherein the user is notified when products and/or services are found that meet the search criteria, and wherein the search of the web sites is performed using the web sites' own search mechanism.

2. Description of Related Art

The state of the art in electronic commerce (e-commerce) or Internet commerce encompasses a wide variety of providers, databases, and technologies. For example, while there are many World Wide Web (WEB) sites that are dedicated to advertising and selling the products of a single vendor, there are now many sites that advertise products and services from multiple vendors. Typically, the types of products and services are related, enabling the user to identify a certain web site with a particular range of products. An example of WEB sites that advertise and sell products from many vendors includes such sites as AMAZON.COM.

Another type of vendor that has been increasing popular on the Internet is an auction house. Users are provided the opportunity to list used products that they want to sell. A ubiquitous example is the popular auction site of EBAY.COM.

Still another type of WEB site that allows products and services to be sold is an electronic version of the classic classified ads of a newspaper. The classified ads are typically associated with a local or regional newspaper, thereby assuring a potential purchaser that the product or service can be picked up locally, even though looking for the item may be taking place on a computer network that is available to anyone in the world.

One of the disadvantages of shopping for products or services on a computer network such as the Internet arises from the very fact that there are so many WEB sites that can be searched. Furthermore, the number of WEB sites that desire to offer a large variety of products out of a desire to provide “one-stop” Internet shopping has grown significantly simply because of the expansion of e-commerce. Thus, even though a user can now have easy access, for example, to every classified advertising section of all major newspapers in the United States, the task of actually going to all those WEB sites to conduct a search is now virtually impossible. The sheer number of WEB sites has grown too large for even the most web-savvy user to be able to peruse in a reasonable amount of time. Thus, a user is left with the only reasonable option and must ignore the vast majority of potential WEB sites that might offer the desired product or service.

The prior art offers a variety of solutions to the problem of how to search a large number of WEB sites for a particular product or service. The most common is the ubiquitous meta search engine such as the search engine provided at the WEB site of GOOGLE.COM. The user enters search terms that are compared to a database that has been previously compiled. Unfortunately, such a meta search engine is not usually up-to-date with information regarding sales of products and services. Meta search engines are usually meant to compile information that does not change as rapidly as sales information in classified advertisements.

Another solution provided by the prior art relates to “shopping agents.” A shopping agent is a computer program that is designed to perform a very specific task. For example, a shopping agent might be capable of going to a WEB site and searching through a database. The shopping agent can be programmed to compensate for a WEB site that changes its interface or the manner in which data is stored. However, agents are typically not rapidly acting devices because they operate according to their own search rules, and thus ignore the interface or search capabilities that might be provided by a WEB site. Thus, an optimized interface would be ignored in favor of its own search algorithm.

Another solution that the prior art has provided for Internet shopping is to compile large databases of particular items. The database does not try to keep up-to-date on the actual items being advertised, but instead tries to keep up-to-date on locations of WEB sites that offer particular products or services. Thus, when a user knows what item is desired, and the location or locations of WEB sites that offer that particular type of products or services are stored in the database, the user can then quickly go to the pre-selected and monitored locations to see prices, descriptions, and availability.

All of the solutions described fail in numerous aspects to solve the problem of how to efficiently look at a larger number of WEB sites for particular goods or services. The solutions fail to take advantage of an existing search capability provided by the WEB sites themselves. The solutions fail to provide rapid searches.

Accordingly, what is needed is a search system and method that enables a user to simultaneously search a wide variety of web sites that might offer products or services that meet the search criteria, wherein the search is always performed using a WEB sites' own optimized search interface. It would be a further advantage to offer an automated search process that can be performed at regular intervals without user intervention, and automatically notify a user when items are found that meet the search criteria.

### BRIEF SUMMARY OF THE INVENTION

It is an object of the present invention to provide a search system and method that enables a user to perform a plurality of searches using the search engine and interface of each specific WEB site.

It is another object to provide automatic searching at pre-defined intervals.

It is another object to provide a search service that does not rely on previously compiled information, but relies only on searches performed at the time of the request for the information.

It is another object to provide a search service that will automatically notify the user whenever an item meeting the search criteria is located.

It is another object to provide a search engine that can be used to search for any definable item, not just products and services being offered for sale.

In a preferred embodiment, the present invention is a system and method for performing a search of multiple WEB sites for a desired product or service, wherein the searches are performed using the protocols and search engine of each WEB site to thereby perform the search as rapidly as possible, wherein the user does not need any knowledge of the interface to each of the WEB sites to be searched, wherein the searches can be performed automatically at a user-selectable interval, and wherein the user is automatically notified whenever a desired product or service is found.

In a first aspect of the invention, a database records a users search options regarding scope of the search, region restrictions, and domain restrictions.

In a second aspect of the invention, a user enters search criteria in the form of a keyword(s) that are used to search previously identified WEB sites.

In a third aspect of the invention, the system performs the search using a native search engine provided by each of the WEB sites.

In a fourth aspect of the invention, the user is notified of search results meeting the search criteria.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is provided as a flowchart of the overall SANS process for performing a search for a product or service of interest.

FIG. 2 is an overview of the hardware and software elements of the present invention shown with logical arrangements.

FIG. 3 is provided as a graphical illustration of the database terms shown in Table 1.

FIG. 4 is provided as a flowchart of the overall SANS process for performing an offer for sale of a product or service.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

The presently preferred embodiment of the invention is a rapid search and notification service (to be referred to hereinafter as SANS). The present invention is a web-based service that enables searching across multiple WEB sites and searching of different databases, regardless of the technology being used.

The present invention was initially developed as a service to provide easy access to multiple auction WEB sites. However, as will become apparent after an explanation of the services offered, the present invention has application to more than just searching for desired products and services to purchase. The present invention provides a much improved system and method for searching for any information, especially when that information is stored at a WEB site that has its own optimized search engine and interface for accessing the search engine.

It is necessary to understand from the outset that the preferred embodiment revolves around the concept of providing a search service for making purchases. However, as will also be explained in an alternative embodiment, the same principles of the present invention can also be used in the process of offering products or services for sale to others.

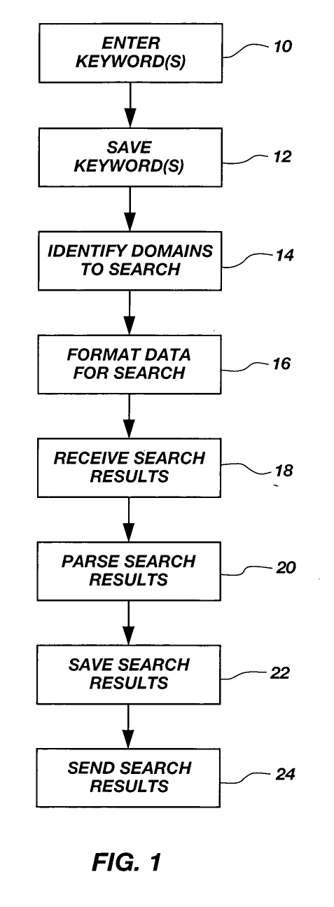

This document begins with an explanation of the process for searching for products and services for sale. FIG. 1 is provided as a flowchart of the overall SANS process for performing a search for a product or service of interest. It is noted from the outset that many of these steps are not order-specific, in that they can be completed out of the order shown for certain steps as will be understood by those skilled in the art.

However, a preliminary step that is not shown is that a user must first register. Registration is necessary for the SANS system to obtain the email address of the user. This email address is used in the SANS process. The user may also input regional information. For example, a zip code, city, state and country might be provided. When the system is narrowing domains based upon a region, the system may use a default region such as a zip code, or it may be user selectable each time a search is formulated.

The first step 10 is where the user enters a keyword or keywords (hereinafter keyword) for the product or service for which SANS is going to search. The keyword is stored in a SANS database in the next step 12. The user must now identify the domains to search in step 14. The user may desire to search all available domains, or limit the search, for example, to a specific region such as a zip code, state or even a country. The specific examples of search limitations selectable by the user and shown by example should not be considered limiting factors of the present invention. Other search limitations may be created for the system, and should be considered to be within the scope of the invention.

The next step 16 is to format the keyword entered by the user for the search. This step is a key aspect of the present invention. There are few standards for how data must be entered at a WEB site. However, it is important that whenever possible, the present invention should use the native search engine of the WEB site. A native search engine, or one provided by the WEB site, is going to be optimized for searching a database that contains information regarding the products or services that are available there.

It is often the case that a database may be accessible through a software agent or other program that is designed to use to perform searches. However, this is a brute-force approach that ignores the benefits of using an interface to a search engine provided for the WEB site. Thus, the agent should generally be slower than the native search engine. Furthermore, an agent may breach or violate security of a WEB site in order to perform its search function. Thus, the owner of the WEB site may take action to block future access to the agent, prompting the need to reprogram the agent to overcome the WEB sites defenses.

Accordingly, it is inefficient and potentially harmful to bypass WEB sites existing protocols and interfaces to its own database. Thus, it is an aspect of the invention that it is far more advantageous to instead learn the commands and protocols of a native interface to a native search engine, and use these commands and protocols in its own search.

Thus, the SANS process will retrieve the commands and protocols for the domains that have been identified by the user to be searched. The keyword is then formatted so as to be in a form suitable for insertion into a native search interface, or formatted for direct access into a native search engine.

Direct access should not be considered to be bypassing the native commands and protocols of WEB site. On the contrary, it may simply be quicker and not be considered a breach of WEB site protocols to directly access a native search engine.

After formatting of the keyword, the SANS process accesses the native search engine directly, or accesses a native search interface. The SANS process inserts the keyword that is now formatted to be received by the native search engine or the native search interface, and requests that the search be performed. This process is repeated for each domain that will be searched. It is likely that each domain will have a unique set of commands or protocols to be used. Thus, the SANS database will store all of these for retrieval in order to conduct a search. It is also the case that these commands and protocols may be updated easily and frequently, in dictated by the actions of the domains.

One aspect of the searching is that may be advantageous to batch the search process. Furthermore, the search is preferably incremental. This means that each time a search is performed at a particular domain, many if not all of the search results may be identical to the last search performed. Therefore, in order to avoid the situation of sending the same search results to the user, the search results will be stored in some manner in the SANS database.

In a first embodiment, it is preferable that the search results be tagged or in some way saved with a time and/or data stamp. In this way, the searches themselves may be conducted on many WEB sites with reference to a time or date. In this way, only new search results are being obtained by the searches, and only new search results are being reported to the user.

In an alternative embodiment, it may not always be possible to search accordingly to time or date. Accordingly, it may be necessary to perform a comparison of previously saved search results with those of a current search in order to determine which search results are new. After this comparison, only the new search results will be sent to the user in a notification email.

The next step 18 is to receive the search results. Because this search system is web-based, the search results are most likely to be either sent to or retrieved by the SANS service in the form of an HTML web page.

After receiving the results page, the next step 20 is to parse the search results. Along with the commands and protocols stored in the SANS database to format and perform the search, the SANS database also saves a parsing instruction set for each domain. A unique parsing instruction set is likely to be needed for each domain because each domain is likely to have a unique format for reporting its search results. The parsing instructions are thus used to extract the desired information from the search results web page.

Once the desired information has been parsed from the search results, the next step 22 is to save the search results in the SANS database. The search results are preferably time-stamped. Time-stamping of search results enables the SANS database to sort them. When a domain has been searched for the first time, all of the search results are saved because they will all be new. However, it may be the case that subsequent searches will only generate incremental changes in the search results as new items that match the search criteria are added to the database of a domain being searched. It is preferred that only the incremental changes are added to the search results for each domain. Advantageously, these incremental changes are also going to be the only search results sent to the user through the notification process.

The next step 24 is to notify the user of the search results. The preferred method of sending notification is through email. The incremental results of each domain are compiled together to form a single document. This document is pasted into the text portion of an email, or attached to an email if the document has been created and saved. Either method of delivery should enable the user to look at the search results and immediately link to the WEB site of the desired product or service. Thus, hyperlinks should be active in either the text portion of the email, or from the attached document. This process

It is preferred that the search results are not constantly sent to the user immediately upon receipt from the domains. Depending upon how and when the search results are received, the user may be constantly inundated by them. Thus, it is preferable to batch the search results in step 24 so that the results are accumulated and sent at some periodic interval. This interval can be user selected, or set by a SANS administrator.

Once the keyword has been entered into the SANS database and the search process enabled, it is a relatively simple process to cancel as well. The user would remove the keyword from the search engine, or use some user selectable option from an interface to the SANS database to cancel the search.

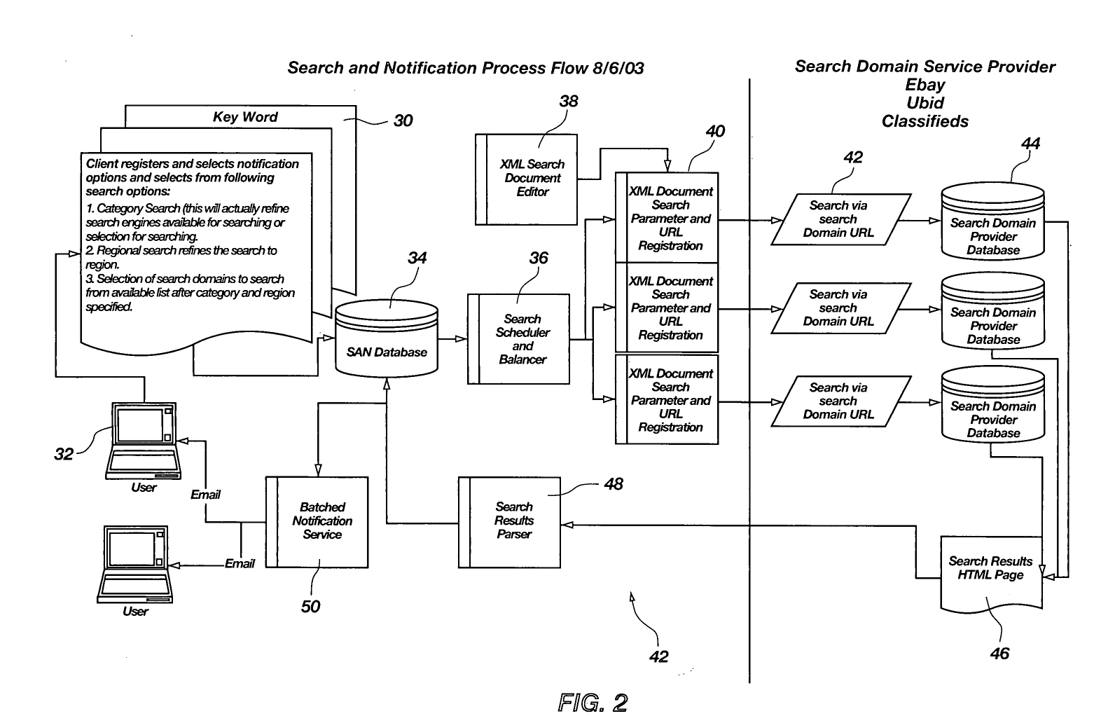

FIG. 2 is a useful overview of the hardware and software elements of the present invention. Thus, the figure is more of a logical representation of the invention.

Beginning with the entry of a keyword in item 30, the user at terminal 32 is requested to provide information to SANS. First, the user registers to setup and account with notification information. The user may choose to perform a category search. This option streamlines the search engine process. In other words, it may not be necessary to search all the searchable domains and their databases when it is known that certain WEB sites definitely do not contain a specific desired category of products or services. By reducing the total number of domains to just selected ones that are known to have desired products or services, the overhead that can be avoided on the SANS database, and at the domains that will not have to be searched, can be significant. It will also have at least some impact on the bandwidth used by the SANS service.

The next user selectable option is to limit the scope of the search to a regional area. A region may be any desired size, from zip code to city to country. This option is generally going to be selected for the convenience of the user.

Even after the user has been able to limit searches by category and region, it may be desirable to further limit the domains to be searched. Thus, the user will be presented with a list based on the category and region, and then either eliminate a few undesirable domains, or select only a few domains from the list to search.

The user preferences described above are stored in the SANS database 34. The SANS database can be any database capable of storing the information described. The SANS database has been implemented in practice using MySQL 4.0. Use of this database software for the SANS database should not be considered to be limiting, and is explained for the purposes of example only.

When the SANS database 34 has been instructed to perform the desired search, a Search Scheduler and Balancer 36 receives the necessary information from the SANS database. It is necessary to have the Search Scheduler and Balancer 36 in order to perform two functions.

The first function performed is that of coordinating searches. Specifically, searches are submitted to the Search Scheduler and Balancer 36 and disposed in a queue for processing. The queue is circular which means that once all of the searches in the queue have been completed, the searches will be repeated at the time interval that has been selected by the user. It is noted that the nature of many of the WEB sites being searched is such that the content may change very rapidly, even many times per day. Accordingly, the search may be repeated quite often for some products and services.

The Search Scheduler and Balancer 36 will also make sure that all searches have a chance to be processed through a complete cycle of the queue. This process is completed even if the schedule function is unintentionally terminated, and the schedule function has to be restarted.

The second function of the Search Scheduler and Balancer 36 is that of balancing the search load. In other words, the balancing function is in charge of balancing the search load on the system running the SANS database, but it is also possible to be sensitive to the load on the domains being searched.

The reason that the search load must be balanced is that each search will require system resources. The balancing function will be used to make sure that the system can handle all of the search requests that are taking place. The balancing function may also be used to determine if the searches that are submitted to the domains do not become such a burden on the domains so as to be perceived as an attack, or an attempt to shutdown the domain.

Because the SANS service is a web-based process, it is natural that an XML Document Editor 38 would also be used to perform the tasks of preparing documents that will interface with the domains to be searched. The commands and protocols stored in the SANS Database 34 are thus used to prepare XML documents 40 that can be used to contact the domains to be searched, and to supply these domains with the correct search parameters in whatever format is used by the particular domain.

FIG. 2 also shows the search processes 42 that are performed by the various domains that have been contact by the SANS service. Each domain is searched by accessing a native search engine that can access the database 44.

Search results are shown to be prepared and sent as HTML documents 46. These HTML documents 46 are sent to a parser 48 that extracts the information that has been found in the databases 44. The parser 48 acts in accordance with a parsing instruction set that is unique to each domain searched, and stored in the SANS database 34.

After parsing, the parsed search results are incrementally stored in the SANS database 34, as well as compiled in a Batched Notification Service 50. At predetermined intervals, the incremental search results are then sent to the user at an email address that was entered at registration.

Table 1 is provided below to explain the terms that are stored in the SANS database in the presently preferred embodiment. The terms, variables, and explanations are only provided for the purposes of illustration of a working example, and should not be interpreted as being limiting factors. Those skilled in the art of database construction will understand more fully the implications of the table. However, it is sufficient to state that the terms below will satisfy implementation of the present invention as explained above.

TABLE 1

| | | | Table | |
|---|---|---|---|---|
| Table | | Table Column | Column | Table Column |
| Name | Table Comment | Name | Datatype | Comment |
| AGENT | This table will store | ADID | numeric | Agent Domain ID |
| DOMAINS | information about all of the | | | |
| | domains that are registered | | | |
| | to run the search. | | | |
| | | ADSAID | | |
| | | ADSDID | | Search Domain ID |
| | | ADCREATEDATE | datetime | Date the agent was |
| | | | | selected to run the |
| | | | | search |
| PERSON | Person table stores | PID | numeric | Primary key. |
| | information about a person or | | | Person Address ID |
| | user in the system | | | |
| | | PFNAME | varchar(40) | Customer First |
| | | | | Name |
| | | PLNAME | | Customer Last |
| | | | | Name |
| | | PEMAIL | varchar(30) | Customer Email |
| | | PHOMEPHONE | | Customer Primary |
| | | | | Phone |
| | | PBUSPHONE | | Customer |
| | | | | secondary phone |
| | | PADDRESS1 | varchar(50) | Customer address |
| | | | | line 1 |
| | | PADDRESS2 | | Customer address |
| | | | | line 2 |
| | | PADDRESS3 | | Customer address |
| | | | | line 3 |
| | | PCITY | | Customer City |
| | | PSTATE | | Customer State |
| | | PCOUNTRY | | Customer Country |
| | | PZIP | varchar(30) | Customer Zip |
| | | PRDATE | datetime | Created Date |
| | | PLASTUPDATE | | |
| | | PMOBILEPHONE | varchar(30) | Mobile phone |
| | | | | number for this |
| | | | | person |
| SEARCH | This table stores a “Search | SAID | numeric | |
| AGENT | Agent” which handles | | | |
| | organizing a search. The | | | |
| | searches take place in a | | | |
| | circular queue and searches | | | |
| | are continually being | | | |
| | executed. | | | |
| | | SAPID | | Primary key. |
| | | | | Person Address ID |
| | | SACREATEDATE | datetime | Date the search |
| | | | | Agent was charged |
| | | SANAME | varchar(80) | This is the name by |
| | | | | which the user will |
| | | | | identify and refer to |
| | | | | this search. |
| | | | | Together with the |
| | | | | SAPID this makes |
| | | | | an alternate key. |
| | | SASTATUS | varchar(1) | Search Agent |
| | | | | Status: ‘A’ = Active |
| | | | | ‘D’ = Disabled |
| | | SASEARCHCYCLENO | numeric | This is the cycle for |
| | | | | which this search |
| | | | | should run. |
| | | SANOTSCHED | varchar(1) | Notification |
| | | | | schedule ‘R’ = Real |
| | | | | time as results |
| | | | | become available |
| | | | | ‘D’ = Daily ‘3’ = Three |
| | | | | Days ‘W’ = Weekly |
| | | SANOTTYPE | | Search notification |
| | | | | Type ‘E’ = Email |
| SEARCH | This table simply stores the | SCNO | numeric | This is the current |
| CYCLE | current search cycle for the | | | cycle that is being |
| | search agents. To figure out | | | processed or |
| | which agents need to be | | | searched. |
| | searched select * from | | | |
| | searchagent, searchcycle | | | |
| | where sacycle != scno. Once | | | |
| | a cycle is completed the | | | |
| | SCNO should be changed to | | | |
| | a new value. | | | |
| SEARCH | Search Domain table stores | SDID | | Search Domain ID |
| DOMAIN | information about a search | | | |
| | domain. Ex. Ebay, Ubid, | | | |
| | Classified ... Along with the | | | |
| | XML file the attributes for | | | |
| | searching this domain is | | | |
| | stored. | | | |
| | | SDNAME | varchar(30) | |
| | | SDXMLFILEPATH | varchar(100) | This field stores the |
| | | | | name and path of |
| | | | | the XML file that |
| | | | | contains the |
| | | | | information for |
| | | | | running a search |
| | | | | for this domain |
| | | SDCREATEDATE | datetime | Date this search |
| | | | | domain was |
| | | | | entered into the |
| | | | | system |
| SEARCH | This table stores the search | SRID | numeric | Search Results ID. |
| RESULTS | results. | | | |
| | | SRSID | | Search Result |
| | | | | Search ID |
| | | SRURL | varchar(100) | URL for the search |
| | | | | results |
| | | SRCREATEDATE | timestamp | Date and time the |
| | | | | search result was |
| | | | | obtained. |
| | | SRNOTIFIEDDATE | | Date the |
| | | | | notification was |
| | | | | sent. If null |
| | | | | notification has not |
| | | | | been sent yet. |
| SEARCHS | This table stores the | SID | numeric | |
| | searches that are made and | | | |
| | the results if necessary. | | | |
| | | SADID | | Agent Domain ID |
| | | STIMESTAMP | timestamp | Time the search |
| | | | | executed. |
| | | SCYCLE | numeric | The cycle in which |
| | | | | this search was |
| | | | | created. |
| SEARCH | This table store all of the | STID | | Unique ID assigned |
| TERMS | search terms available for a | | | for this search term |
| | search agent, which may only | | | |
| | be one word or phrase. The | | | |
| | Boolean logic in most cases | | | |
| | will be handled be the search | | | |
| | domains search engine. | | | |
| | | STSAID | | |
| | | STTEXT | text | Text used in |
| | | | | performing the |
| | | | | search. |

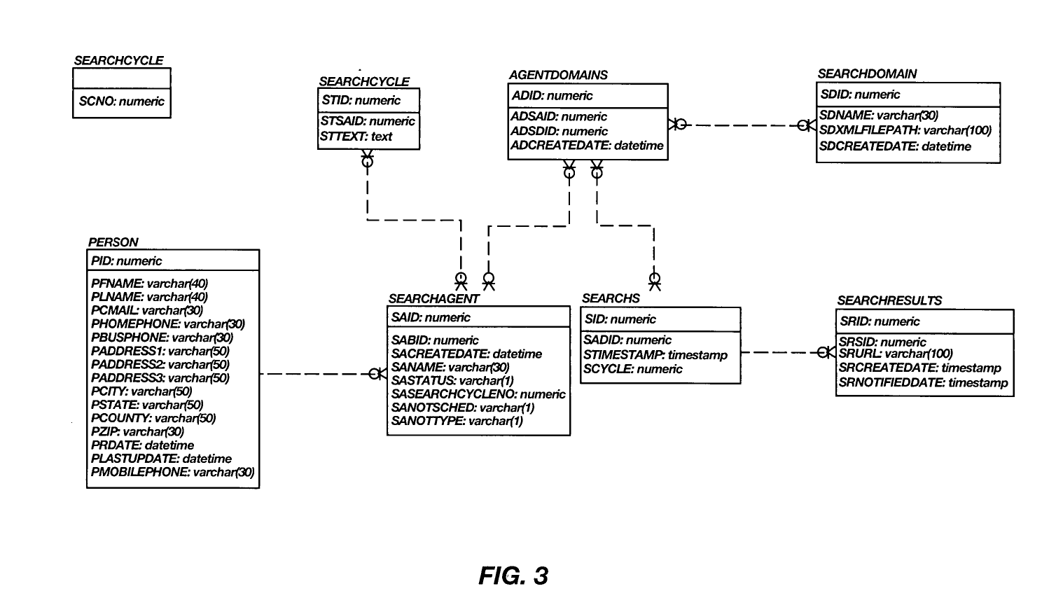

FIG. 3 is provided as a graphical illustration of the database terms shown in Table 1, and is also provided for illustration purposes only.

Having no fully explained the operation of the present invention when operated to perform searches for products and services that are advertised on various WEB sites, alternative embodiments of the present invention can now be explained. The advantages to searching taught by the present invention are not confined to e-commerce and Internet shopping. There are other applications of the capabilities of the present invention extend far beyond. For example, consider generally the myriad of WEB sites that act as storage of information. The information stored may come from many different disciplines. One use of these WEB sites is simply to function as repositories of information for those seeking it.

As with e-commerce, these repositories also come with their own methods of access, such as customized search engines, unique database arrangements, and unique requirements for access to them. The present invention envisions these repositories also being accessible by a single application such as the SANS service of the present invention. Accordingly, these repositories of information could all be searched in much the same way as the e-commerce WEB sites of the present invention, enabling the information to be more readily accessible, and thereby made more useful to those who can use the information stored therein.

To this point, the present invention has been described as only a means for searching for information, products or services. However, in an alternative embodiment, the present invention also enables e-commerce by assisting in the advertising of products and services.

Consider the many auction houses or classified advertising WEB sites. These WEB sites enable a user to offer items for purchase to the highest bidder. Others simply offer items at set prices.

The present invention can also be used to enable a seller to virtually simultaneously offer up a product or service for sale. Placing a product or service up for sale is performed by using the same command and protocol information stored in the SANS database. However, instead of searching, the process operates in reverse, and the command and protocol information is used to format an offer for sale, and then request that the offer for sale be posted on the various WEB sites.

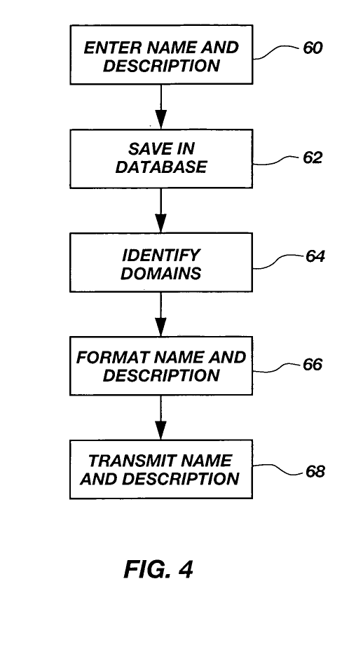

FIG. 4 is an illustration of a flowchart of the process for offering a product or service for sale on an e-commerce WEB site that is provided to enable a user to make such an offer. The first step 60 is to enter a name of the product or service, and a brief description thereof. The next step 62 is to store the name and description in the SANS database. The next step 64 is to identify those domains on which the product or service is to be offered for sale. This might be done in manner similar to the search process, where a category and region can be defined before the user makes a final determination of which sites to go to.

It is observed that many such WEB sites may require fees as part of the process for their use. It may be considered to be a part of the sales process that means of payment can also be stored and sent to the identified WEB sites when needed.

The next step 66 is to format the name and description information so that it can be received by the identified WEB sites. This may operate, for example, by creating an XML document that can be used to enter the name and description in the appropriate locations of a form or other interface at an identified web site. The next step 68 is the step of transmitting the formatted name and description information to the plurality of WEB sites.

It should be considered an element of this embodiment that the offer for sale can also be withdrawn as necessary. It is also an element of this embodiment that the offer for sale may need to be posted more than once if a particular WEB site cancels an offer for sale after an interval of time. This process of reposting an offer for sale might be set to occur automatically at predetermined intervals, or to require some manual intervention, especially in the case of WEB sites where payment is required in order to post an offer for sale.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

1. A method for searching for products or services listed for sale on a plurality of web sites, said method comprising the steps of:
(1) entering at least one search term as a keyword;
(2) identifying a plurality of web sites to be searched;
(3) providing a database of commands and protocols for entering a keyword in the plurality of web sites;
(4) formatting the keyword so that it can be entered into a native search engine at each of the plurality of web sites; and
(5) entering the formatted keyword and the commands to request a search into the native search engine used at each of the plurality of web sites.

2. The method as defined in claim 1 wherein the method further comprises the steps of:
(1) receiving the search results from the native search engines at the plurality of web sites;
(2) parsing the search results to extract information regarding the products or services being searched for; and
(3) transmitting the search results to an email address.

3. The method as defined in claim 2 wherein the method further comprises the step of storing the parsed search results in the database.

4. The method as defined in claim 3 wherein the method further comprises the step of adding to the parsed search results stored in the database so as to reflect incremental increases in the parsed search results.

5. The method as defined in claim 4 wherein the method further comprises the step of adding a time stamp to each of the parsed search results.

6. The method as defined in claim 4 wherein the method further comprises the step of transmitting the incremental increases in the parsed search results to the email address, to thereby avoid resending all the search results for any of the plurality of web sites.

7. The method as defined in claim 6 wherein the method further comprises the step of batching the transmission of incremental increases in the parsed search results to thereby prevent the email address from constantly receiving search results as they are received.

8. The method as defined in claim 7 wherein the method further comprises the step of automatically repeating step 5 of claim 1 at a user selectable interval of time to thereby enable the search to be repeated a plurality of times each day.

9. The method as defined in claim 1 wherein the method further comprises the step of storing the keyword in a database.

10. The method as defined in claim 1 wherein the method of identifying the plurality of web sites to search further comprises the step of selecting from a category of web sites that are associated with the product or service to be searched for to thereby eliminate overhead by not having to search all known web sites.

11. The method as defined in claim 10 wherein the method of identifying the plurality of web sites to search further comprises the step of selecting from a geographical region in order to limit overhead by not having to search all known web sites.

12. The method as defined in claim 11 wherein the method further comprises the step of selecting a plurality of web sites to search from a list of category and region limited web sites.

13. The method as defined in claim 1 wherein the step of formatting the keyword so that it can be entered into a native search engine further comprises the step of generating an XML document, wherein the XML document is transmitted to a corresponding one of the plurality of web sites to thereby enter in a keyword into the native search engine.

14. The method as defined in claim 1 wherein the method further comprises the step of registering a user, wherein the user provides an email address to which search results are to be transmitted.

15. The method as defined in claim 2 wherein the method further comprises the step of providing a plurality of parsing instruction sets that are stored in the database, wherein each of the plurality of parsing instruction sets corresponds to at least one of the plurality of web sites to be searched.

16. A system for searching for products or services listed for sale on a plurality of web sites, said system comprising:
a database for storing search criteria, parsing instruction sets, and search results;
a search scheduler and balancer for storing searches requests in a repeatable queue, and for controlling the number of searches being performed at any given time in order to avoid overloading system resources; and
an XML search document editor for creating XML documents that are used to enter at least one search keyword into a native search engine of the plurality of web sites.

17. The system as defined in claim 16 wherein the system further comprises a parser engine for receiving search results from the plurality of web pages and extracting desired information therefrom.

18. The system as defined in claim 17 wherein he system further comprises a batched notification service for receiving parsed search results from the parser engine, wherein the batched notification service stores the parsed search results for a period of time and then transmits the parsed search results to an email address.

19. A method for transmitting an offer for sale of a product or service to a plurality web sites, said method comprising the steps of:
(1) entering a name for the product or service to be offered for sale;
(2) entering a description of the product or the service;
(3) storing the name and the description of the product or the service in a database;
(4) identifying the plurality of web sites on which the product or the service is to be offered for sale;
(5) formatting the name and the description of the product or the service so that the terms can be received by each of the plurality of web sites to which the terms are transmitted; and
(6) transmitting the formatted terms to the identified plurality of web sites.

20. The method as defined in claim 19 wherein the method further comprises the step of retrieving commands and protocols from the database to thereby format the terms for each of the plurality of web sites.

21. The method as defined in claim 20 wherein the method further comprises the step of automatically repeating step 6 of claim 19 at a user selectable interval of time to thereby enable the offer of the products or the services to be repeated.

22. The method as defined in claim 21 wherein the method further comprises the step of storing the terms in the database.

23. The method as defined in claim 19 wherein the method of identifying the plurality of web sites to offer the product or the service further comprises the step of selecting from a category of web sites that are associated with the product or service to be offered to thereby eliminate overhead by not having to offer the product or service to all known web sites.

24. The method as defined in claim 23 wherein the method of identifying the plurality of web sites to offer the product or service further comprises the step of selecting from a geographical region in order to limit overhead by not having to offer to all known web sites.

25. The method as defined in claim 24 wherein the method further comprises the step of selecting a plurality of web sites to offer the product or service from a list of category and region limited web sites.

26. The method as defined in claim 19 wherein the step of formatting the name and the description of the product or the service so that the terms can be received by each of the plurality of web sites further comprises the step of generating an XML document, wherein the XML document is transmitted to a corresponding one of the plurality of web sites to thereby enter the terms thereinto.

27. The method as defined in claim 20 wherein the method further comprises the step of providing a plurality of parsing instruction sets that are stored in the database, wherein each of the plurality of parsing instruction sets corresponds to at least one of the plurality of web sites where the product or service is to be offered for sale.

28. A method for searching for information from a plurality of web sites, said method comprising the steps of:
(1) entering at least one keyword;
(2) identifying a plurality of web sites to be searched;
(3) providing a database of commands for entering the at least one keyword in the plurality of web sites;
(4) formatting the keyword so that it can be entered into a native search engine at each of the plurality of web sites; and
(5) entering into the native search engine used at each of the plurality of web sites the formatted keyword and the commands to request a search.

29. The method as defined in claim 28 wherein the method further comprises the steps of:
(1) receiving the search results from the native search engines at the plurality of web sites;
(2) parsing the search results to extract information being searched for; and
(3) transmitting the search results to an email address.

30. The method as defined in claim 29 wherein the method further comprises the step of storing the parsed search results in the database.

31. The method as defined in claim 30 wherein the method further comprises the step of adding to the parsed search results stored in the database so as to reflect incremental increases in the parsed search results.

32. The method as defined in claim 31 wherein the method further comprises the step of adding a time stamp to each of the parsed search results.

33. The method as defined in claim 32 wherein the method further comprises the step of transmitting the incremental increases in the parsed search results to the email address, to thereby avoid resending all the search results for any of the plurality of web sites.

34. The method as defined in claim 33 wherein the method further comprises the step of batching the transmission of incremental increases in the parsed search results to thereby prevent the email address from constantly receiving search results as they are received.

35. The method as defined in claim 34 wherein the method further comprises the step of automatically repeating step 5 of claim 1 at a user selectable interval of time to thereby enable the search to be repeated a plurality of times each day.

36. The method as defined in claim 28 wherein the method further comprises the step of storing the keyword in a database.

37. The method as defined in claim 28 wherein the method of identifying the plurality of web sites to search further comprises the step of selecting from a category of web sites that are associated with the information to be searched for to thereby eliminate overhead by not having to search all known web sites.

38. The method as defined in claim 37 wherein the method of identifying the plurality of web sites to search further comprises the step of selecting from a geographical region in order to limit overhead by not having to search all known web sites.

39. The method as defined in claim 38 wherein the method further comprises the step of selecting a plurality of web sites to search from a list of category and region limited web sites.

40. The method as defined in claim 28 wherein the step of formatting the keyword so that it can be entered into a native search engine further comprises the step of generating an XML document, wherein the XML document is transmitted to a corresponding one of the plurality of web sites to thereby enter in a keyword into the native search engine.

41. The method as defined in claim 28 wherein the method further comprises the step of registering a user, wherein the user provides an email address to which search results are to be transmitted.

42. The method as defined in claim 29 wherein the method further comprises the step of providing a plurality of parsing instruction sets that are stored in the database, wherein each of the plurality of parsing instruction sets corresponds to at least one of the plurality of web sites to be searched.

43. A method for searching a plurality of web sites, said method comprising the steps of:
(1) providing at least one search term;
(2) identifying a plurality of web sites to be searched;
(3) formatting the at least one search term so that it can be entered into a native search engine at each of the plurality of web sites; and
(4) requesting a search be performed from each of the plurality of web sites using the at least one search term.

44. The method as defined in claim 43 wherein the method further comprises the step of repeating the search at the plurality of web sites at a user selectable time interval.

45. The method as defined in claim 43 wherein the method further comprises the steps of:
(1) receiving the search results from the native search engines at the plurality of web sites;
(2) parsing the search results to extract information regarding the at least one search term; and
(3) transmitting the search results to an email address.
